(19) United States
(12) Patent Application Publication
(10) Pub. No.: US 2021/0209682 A1
(43) Pub. Date: Jul. 8, 2021

(54) Artificial Intelligence (AI) Enabled Blockchain Based Trading Partner Onboarding Optimization

(71) Applicant: INTERNATIONAL BUSINESS MACHINES CORPORATION, Armonk, NY (US)

(72) Inventors: Rahul Jain, Kolkata (IN); Manjit Singh Sodhi, Bangalore (IN)

(21) Appl. No.: 16/736,381

(22) Filed: Jan. 7, 2020

(51) Int. Cl. G06Q 40/04; G06N 20/00; G06F 40/20; H04L 9/06

(52) U.S. Cl. CPC G06Q 40/04; G06N 20/00; H04L 2209/38; H04L 9/0637; H04L 9/0643; G06F 40/20

(57) ABSTRACT

A computer-implemented method implemented by an AI onboarding system for performing trading partner onboarding. The method performs artificial intelligence (AI) training to learn onboarding information requirements. The method submits a transaction proposal to a blockchain business network (BBN) for obtaining a new business trading partner that requires trading partner onboarding. The method sends a business trading partner survey to the new business trading partner. The method monitors for queries regarding the business trading partner survey from the new business trading partner. The method provides responses to the queries based on the AI training. The method verifies using the AI training that the business trading partner survey is completed correctly by the new business trading partner.

### BACKGROUND

The present disclosure relates generally to systems and methods for providing Artificial Intelligence (AI) enabled blockchain based trading partner onboarding optimization.

Trading partner onboarding is the process of enabling a system of a first trading partner to communicate with a system of a second trading partner so they can perform various business transactions. The onboarding process can include the configuration of a partner's Electronic Data Interchange (EDI) profile and building out the necessary maps to exchange business data from one system to another system. Inefficient trading partner onboarding can jeopardize revenue, and put business relationships at risk if data exchanges and standards are not implemented correctly.

Currently, trading partner onboarding is carried out by the onboarding personnel by following a process that is monotonous, time-consuming, and prone to error. This process consumes resources, both human and computational, as well as the progress of the project. The delay in onboarding can lead to delays in getting business from the partner (in the form of transaction flow, data transformation services etc.) which effects a company's business interests. Other approaches to onboarding rely on rule-based products that systematically carry out tasks for partner onboarding. However, these rules-based products still lack the capability for last-mile automation, and thus require more frequent manual intervention.

### SUMMARY

The disclosed embodiments include a system, computer program product, and computer-implemented method for providing trading partner onboarding. In an embodiment, a computer-implemented method performs artificial intelligence (AI) training to learn onboarding information requirements. The method submits a transaction proposal to a blockchain business network (BBN) for obtaining a new business trading partner that requires trading partner onboarding. The method sends a business trading partner survey to the new business trading partner. The method monitors for queries regarding the business trading partner survey from the new business trading partner. The method provides responses to the queries based on the AI training. The method verifies using the AI training that the business trading partner survey is completed correctly by the new business trading partner.

Optionally, in some embodiments, the method identifies additional questions based on the information provided by the new business trading partner on the business trading partner survey.

Optionally, in some embodiments, the method sends responses to all questions collected from the new business trading partner to the BBN for endorsement and validation.

Optionally, in some embodiments, the method stores the responses to all questions collected from the new business trading partner in a Partner Onboarding Database (POD) after being validated by the BBN.

Optionally, in some embodiments, the method raises an alert for manual intervention by an onboarding consultant if a response to a question if not validated by the BBN.

Optionally, in some embodiments, the method notifies an onboarding consultant for any query that the AI onboarding system is unable to provide a response to the new business trading partner.

Optionally, in some embodiments, the method provides a ranking of the responses to a query based on the prior business trading partner survey information of the B2B trading partners.

Optionally, in some embodiments, the method processes the queries regarding the business trading partner survey from the new business trading partner using natural language processing (NLP).

Optionally, in some embodiments, the method stores document identifiers along with the corresponding organization identifier (ID) and interaction ID in the BBN.

Optionally, in some embodiments, the method stores the business trading partner survey completed by the new business trading partner in a Partner Onboarding Database (POD).

Optionally, in some embodiments, the method periodically performs additional AI training using updated business trading partner survey information in the POD.

Optionally, in some embodiments, the method receives organization ID of the new business trading partner from the BBN after proper endorsement and validation.

Other embodiments and advantages of the disclosed embodiments are further described in the detailed description.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram illustrating trading partner onboarding network in accordance with an embodiment of the present disclosure.

FIG. 2 is a schematic diagram illustrating an AI onboarding system in accordance with an embodiment of the present disclosure.

FIG. 3 is flowchart illustrating a trading partner onboarding process in accordance with an embodiment of the present disclosure.

FIG. 4 is flowchart illustrating a trading partner onboarding process in accordance with an embodiment of the present disclosure.

FIGS. 5A-5C are flowcharts illustrating an example dialogue during a trading partner onboarding process in accordance with an embodiment of the present disclosure.

FIG. 6 is a schematic diagram illustrating a trading partner onboarding updating in accordance with an embodiment of the present disclosure.

FIG. 7 is a block diagram illustrating a hardware architecture of a system according to an embodiment of the present disclosure in which aspects of the illustrative embodiments may be implemented.

The illustrated figures are only exemplary and are not intended to assert or imply any limitation with regard to the environment, architecture, design, or process in which different embodiments may be implemented.

### DETAILED DESCRIPTION

It should be understood at the outset that, although an illustrative implementation of one or more embodiments are provided below, the disclosed systems, computer program product, and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

As used within the written disclosure and in the claims, the terms “including” and “comprising” are used in an open-ended fashion, and thus should be interpreted to mean “including, but not limited to”. Unless otherwise indicated, as used throughout this document, “or” does not require mutual exclusivity, and the singular forms “a”, “an” and “the” are intended to include the plural forms as well, unless the context clearly indicates otherwise.

A module or unit as referenced herein may comprise one or more hardware or electrical components such as electrical circuitry, processors, and memory that may be specially configured to perform a particular function. The memory may be volatile memory or non-volatile memory that stores data such as, but not limited to, computer executable instructions, machine code, and other various forms of data. The module or unit may be configured to use the data to execute one or more instructions to perform one or more tasks. In certain instances, a module may also refer to a particular set of functions, software instructions, or circuitry that is configured to perform a specific task. For example, a module may comprise of software components such as, but not limited to, data access objects, service components, user interface components, application programming interface (API) components; hardware components such as electrical circuitry, processors, and memory; and/or a combination thereof. As referenced herein, computer executable instructions may be in any form including, but not limited to, machine code, assembly code, and high-level programming code written in any programming language.

The current disclosure describes various embodiments for automating and optimizing of the trading partner onboarding process using a cognitive approach. In particular, the current disclosure targets the initial steps toward doing Business to Business (B2B) trading partner onboarding on the environment of the service provider. The disclosed embodiments seek to optimize and improve the experience using a B2B cognitive agent. In some embodiments, machine learning is used to generate confidence scores. In addition, the disclosed embodiments use domain specific natural language processing and generation to make the trading partner onboarding process more intuitive, seamless, and cost-effective. The disclosed embodiments use both AI and blockchain based onboarding that further minimizes manual intervention and thus expedites trading partner onboarding. Additionally, the disclosed embodiments can determine new interaction flows, introduce new questions, use domain specific understanding for retrieving the answers to questions from the partner with varying confidence scores to enable the end user to provide inputs with higher certainty based on multiple parameters like history, current conversation analysis, etc., and improve the experience by feedback and analysis using the history of communications with business trading partners during the onboarding process. In various embodiments, distributed ledger technology is used to authorize onboarding, validate partner data, and maintain transaction history to be leveraged by organizational units for audit, billing, and training of the automation agent. The disclosed embodiments can dynamically determine and provide a new parameter to the domain-specific machine learning (ML) clustering model thus dynamically refining the model.

Advantages of the disclosed embodiments includes increase value in B2B outsourcing business, minimize human resource, achieve quicker and more concrete suggestions to any questions that a new trading partner might be unsure of the proper answers, reduce cost, enhance customer experience, create a self-learning model, and overall minimize the time for onboarding a new trading partner.

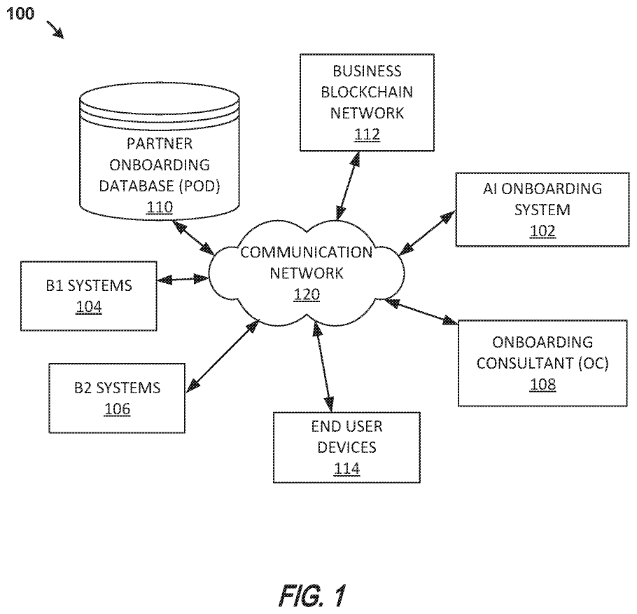

FIG. 1 is a schematic diagram illustrating trading partner onboarding network 100 in accordance with an embodiment of the present disclosure. The trading partner onboarding network 100 includes an Artificial Intelligence (AI) Onboarding System 102, various trading partner systems such as business one (B1) systems 104 and business two (B2) systems 106, an Onboarding Consultant (OC) system 108, a Partner Onboarding Database (POD) 110, a Business Blockchain Network (BBN) 112, and one or more End User devices 114. The various systems in the trading partner onboarding network 100 can communicate data with each other over a communication network 120. The communication network 120 may include both wired and wireless links, and may comprise of multiple links passing through one or more communication subnetworks (e.g., through various service provider networks). The subnetworks may include private networks and/or public networks such as the Internet. The communication network 120 can include various network devices such as, but not limited to, routers, firewalls, servers, and switches. In some embodiments, the communication network 120 is direct link between one or more systems in the trading partner onboarding network 100 (e.g., a wired or wireless link between the AI onboarding system 102 and an End User device 114).

As will be described herein, the AI onboarding system 102 is a system that uses AI and blockchain based onboarding to further minimize manual intervention during a trading partner onboarding process to reduce resource cost such as personnel, reduce errors made by manual entries, securely identify new trading partners, and expedite the trading partner onboarding process. In an embodiment, the AI onboarding system 102 performs AI training (e.g., using machine learning) to learn onboarding information requirements based on prior completed survey information for B2B trading partners. The prior completed survey information for B2B trading partners is stored in a database such as the POD 110. In an embodiment, the AI onboarding system 102 uses machine learning algorithms to perform data analysis on the prior completed survey information for B2B trading partners to identify patterns, statistics, and/or generate analytical models that can be used by the AI onboarding system 102 to make decisions as to whether the information in a survey for a new B2B trading partner is correct without human intervention. The AI onboarding system 102 can also be trained to provide automated responses to queries from a new B2B trading partner regarding requested information on a survey. In an embodiment, the AI onboarding system 102 ranks the possible responses to the survey corresponding to a query from most likely response to least likely response based on its AI training. In some embodiments, if the AI onboarding system 102 is unable to provide a response to a particular query, the AI onboarding system 102 forwards the query to the OC system 108 to allow an onboarding consultant to respond to the query.

In an embodiment, the AI onboarding system 102 communicates with the BBN 112 to identify or validate a new B2B trading partner. The BBN 112 may comprise a number of systems or internal units of an organization that are used to approve a new trading partner. If a new trading partner is approved or validated by the BBN 112, a new block of data containing information identifying the new trading partner is created. The new block of data is then added to an existing blockchain. A blockchain is a time-stamped series of immutable record of data (i.e., cannot be changed) that is managed and stored by a cluster of computers instead by a centralized system. Each of these blocks of data (i.e. block) are secured and bound to each other using cryptographic principles (i.e. chain). The information recorded on a blockchain can take on any form, however this information must be agreed upon by the each of the systems in the BBN 112 before it can be added to the blockchain. All transactions that are recorded on the blockchain are available for viewing by any of the systems in the BBN 112.

The End User device 114 can be any type of electronic device capable of communicating over the communication network 120. For example, the end user device 114 may be a personal computer, a portable electronic device such as a laptop, tablet, or smart phone that is utilized by an end user. The end user may be a person associated with a particular business that it is being onboarded (e.g., information technology (IT) personnel) or other personnel associated with the onboarding process of a business trading partner. For example, the end user may be the person that is providing the information about B1 systems 104 for onboarding of the B1 systems 104 with the B2 systems 106 or with the AI onboarding system 102. In some embodiments, one or more components/systems in the trading partner onboarding network 100 can be combined. For example, in an embodiment, the functions of the AI onboarding system 102 can be integrated as part of a business trading partner system (e.g., B1 systems 104).

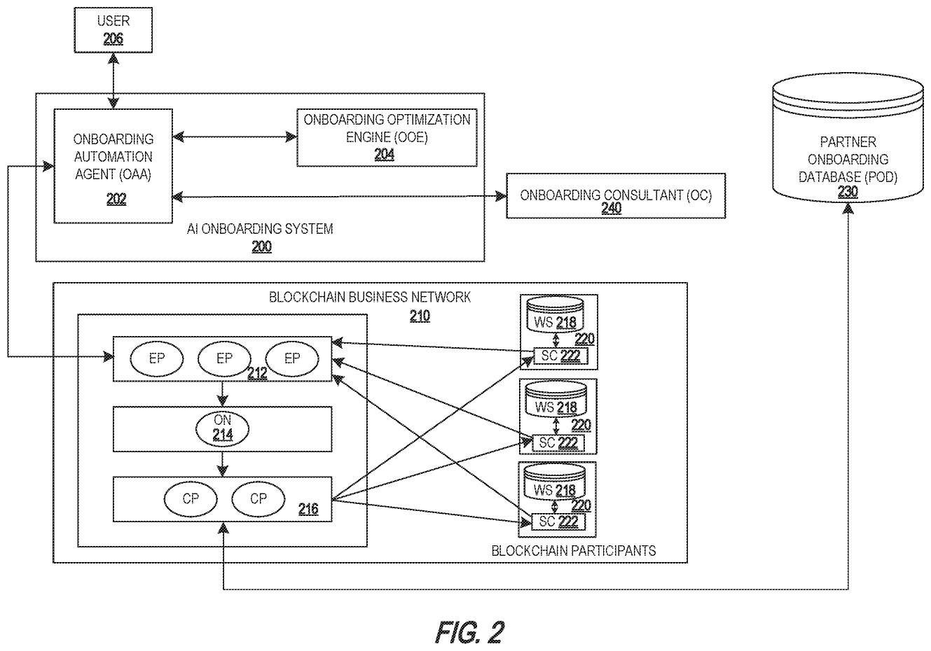

FIG. 2 is a schematic diagram illustrating an AI onboarding system 200 in accordance with an embodiment of the present disclosure. The AI onboarding system 200 is an example embodiment of the AI onboarding system 102 described in FIG. 1. In an embodiment, the AI onboarding system 200 includes an Onboarding Automation Agent (OAA) 202 and an Onboarding Optimization Engine (OOE) 204. The Onboarding Automation Agent 202 interacts with the Onboarding Optimization Engine 204 to provide automated onboarding of a trading partner in accordance with the disclosed embodiments. In an embodiment, a user 206 provides instructions and/or requests to the Onboarding Automation Agent 202 to initiate the onboarding of one or more new business trading partners. The user 206 may be a local user of the AI onboarding system 200 or may be a remote user that communicates the request (e.g., using an End User device 114 in FIG. 1) over a network to the AI onboarding system 200.

In an embodiment, the Onboarding Automation Agent 202 submits a transaction proposal to the Blockchain Business Network (BBN) 210 for obtaining one or more organizations (i.e., a set of organizations) that require trading partner onboarding. In an embodiment, the BBN 210 comprises a set of Endorsing Peers (EPs) 212 such as internal units of an organization that are used to endorse/validate organizations that require trading partner onboarding. An endorsing peer is the peer that will “endorse”/provide the seal of approval to a transaction when it is proposed. The set of Endorsing Peers 212 communicates the transaction request to an Ordering Node (ON) 214. In an embodiment, the Ordering Node 214 maintains a list of organizations of approved trading partners. The Ordering Node 214 controls or restricts who can read and write data to the list of organizations of approved trading partners. In an embodiment, the Ordering Node 214 communicates with a set of Committing Peers (CPs) 216. The set of Committing Peers 216 verify endorsements and validate transaction results, prior to committing transactions to the blockchain. In particular, the set of Committing Peers 216 validates a transaction by checking to make sure that the read-write (RW) sets still match the current world state (WS) 218 stored by the blockchain participants 220. The World State 218 holds a cache of the current value of these states. The read set contains a list of unique keys and their committed versions that the transaction reads during simulation. The write set contains a list of unique keys (though there can be overlap with the keys present in the read set) and their new values that the transaction writes. In an embodiment, the set of Committing Peers 216 uses the read set portion of the read-write set for checking the validity of a transaction and the write set portion of the read-write set for updating the versions and the values of the affected keys. The set of Committing Peers 216 write data to the Partner Onboarding Database (POD) 230. A Smart Contract (SC) 222 defines the executable logic that generates new facts that are added to the ledger stored by each Endorsing Peer in the set of Endorsing Peers (EPs) 212. In an embodiment, the Smart Contract 222 manages access and modifications to a set of key-value pairs in the World State 218.

In an embodiment, once a set of organizations that require trading partner onboarding are validated by the BBN 210, the Onboarding Automation Agent 202 contacts the organization by sending an intimation to start a conversation. As will be further described, this process includes sending a survey form to the organizations or a user associated with the organization. The survey form requests information from the organization that is required for business trading onboarding. In an embodiment, the Onboarding Automation Agent 202 is configured to receive and automatically provide responses to a user's queries regarding the requested information on the survey. In an embodiment, the Onboarding Automation Agent 202 may communicate with the Onboarding Optimization Engine 204 to generate response options for the user's queries. If at any point, the Onboarding Automation Agent 202 is unable to provide a response to a user's query, the Onboarding Automation Agent 202 may communicate the query to an Onboarding Consultant (OC) 240 to provide additional assistance to the user. In an embodiment, once a completed and accurate survey is received and verified by the Onboarding Automation Agent 202, the Onboarding Automation Agent 202 stores the new survey in the Partner Onboarding Database 230. The Onboarding Optimization Engine 204 can be configured to periodically perform additional training using the additional information stored in the Partner Onboarding Database 230 to further optimize the onboarding process and to provide better responses to future queries during the onboarding process.

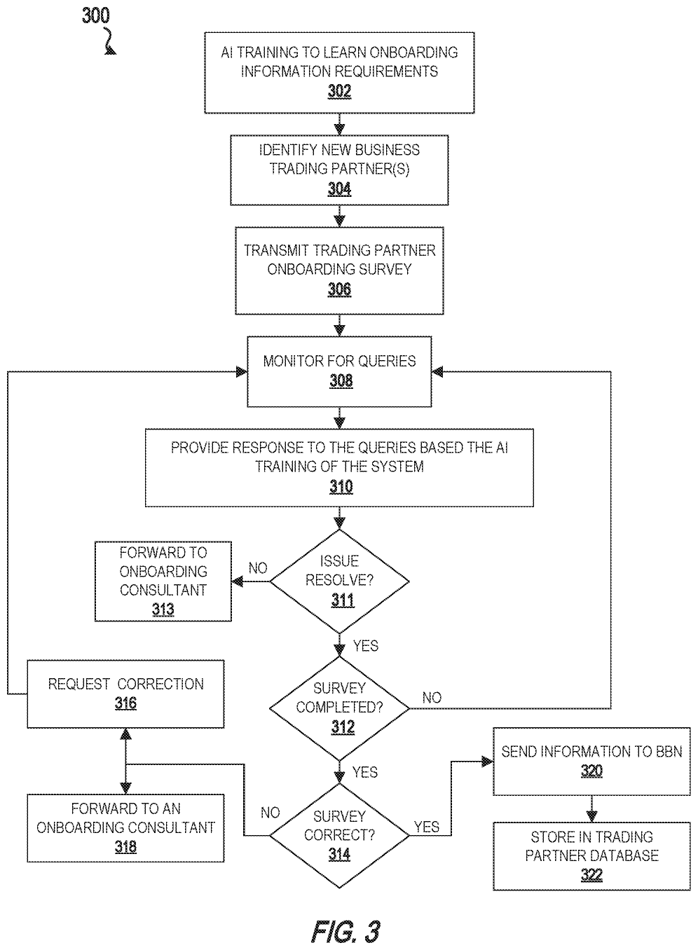

FIG. 3 is flowchart illustrating a process 300 for performing trading partner onboarding in accordance with an embodiment of the present disclosure. The process 300 can be implemented as instructions stored in memory and executed using a processor of a system such as the AI onboarding system 102 in FIG. 1. The process 300 begins at step 302 by performing AI training to learn onboarding information requirements. In an embodiment, the process 300 uses machine learning to learn onboarding information requirements based on prior survey information for B2B trading partners. At step 304, the process 300 identifies at least one new business trading partner for performing trading partner onboarding using a BBN. For example, in an embodiment, the process 300, using the BBN, obtains authorization from various internal units like Sales, Offering Management, etc., regarding organization details that are required to be onboarded.

The process 300, at step 306, sends an intimation to start the conversation with the new business trading partner, and transmits a trading partner onboarding survey to the new business trading partner to obtain survey information for performing trading partner onboarding of the new business trading partner. The trading partner onboarding survey can include general standard questions, contact information, electronic data system information, transaction types, network providers, protocol, and other questions required for performing trading partner onboarding.

At step 308, the process 300 monitors for queries regarding the trading partner onboarding survey from the new business trading partner. For example, a user filling out the trading partner onboarding survey may have questions regarding one or more requested information on the trading partner onboarding survey. For instance, a user may ask “Will smoke testing be enough to check all capabilities?” The process 300, at step 310, provides one or more responses to the queries based on the AI training of the system. In an embodiment, the process 300 provides NLP-based or ranked answers in response to the received queries. The ranking of the answers may be determined by an onboarding optimization engine (e.g., OOE 204 in FIG. 2) that is configured to determine the best possible answers to a query using artificial intelligence. The ranking can be updated periodically or determined in real time in response to a query.

The process 300 continues to monitor for queries and provide responses to the queries until the business trading partner submits a completed survey form at step 312. In an embodiment, if a predefined amount of time has elapsed, and the business trading partner has not submitted any queries or a completed survey form, the process 300 can send a follow up message to the business trading partner reminding the business trading partner to complete the survey. The predefined amount of time can be set to any user-specified time period (e.g., after 1 day, 3 days, etc.). In an embodiment, at step 311, the process 300 determines whether a response to a received query resolves the particular issue (e.g., if the query is repeated or additional details are requested regarding the same query then the issue is not resolved). If the issue cannot be resolved the AI training of the system (e.g., by providing additional information in response to the query), the process 300, at step 313, forwards the query to an onboarding consultant for further review.

Once the new business trading partner submits the completed survey form at step 312, the process 300, at step 314, verifies using the AI training of the system that the trading partner onboarding survey is completed correctly by the new business trading partner. In an embodiment, if the process 300 determines that the trading partner onboarding survey is not complete, or one or more requested information has not been completed correctly, the process 300, at step 316, requests the new business trading partner correct the inaccurate or incomplete information. In another embodiment, the process 300, at step 318, forwards the trading partner onboarding survey to an onboarding consultant for further review. If the process 300 determines that the trading partner onboarding survey is complete and accurate, the process 300, at step 320, sends details from the completed survey to the BBM to provide the organization the required details to onboard the new trading partner. Additionally, the process 300, at step 322, can store the completed trading partner onboarding survey in a database (e.g., POD 110 in FIG. 1). The process 300 can periodically perform additional AI training using the updated survey information in the database.

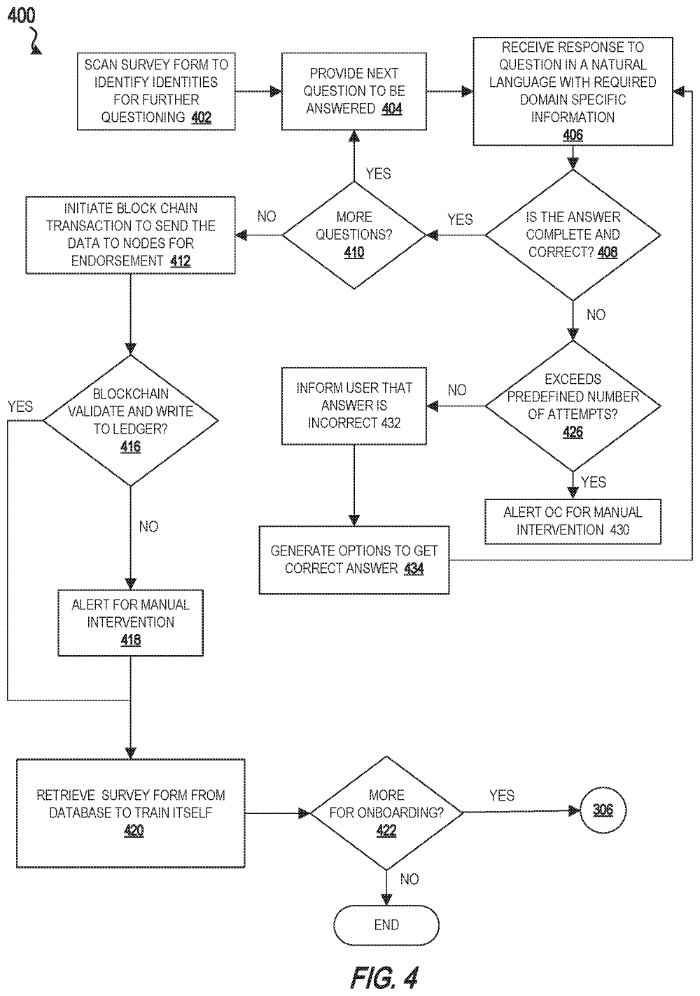

In some embodiments, the process 300 can automatically identify additional surveys or follow up questions based on the information provided in the completed trading partner onboarding survey. As an example, FIG. 4 illustrates a process 400 that is part of the trading partner onboarding process in accordance with an embodiment of the present disclosure. The process 400 can be implemented as instructions stored in memory and executed using a processor of a system such as the AI onboarding system 102 in FIG. 1. The process 400, at step 402, scans the survey form to identify identities for further questioning. At step 404, the process 400 provides the new trading partner the next question to be answered. The process 400, at step 406, receives the response to the question. In an embodiment, the response is in a natural language (i.e., a human language such as English or Spanish). In an embodiment, the process 400 parses the response to obtain required domain specific information (i.e., specific requested information) such as a name, a protocol, or port number. At step 408, the process 400 determines whether the answer is complete and correct. If the answer is not complete or correct (e.g., invalid IP address or insufficient digits of a phone number), the process 400, at step 426, determines whether a predefined number of attempts at providing the answer has been exceeded. For example, the predefined number of attempts can be set to three (3) or any other number. In an embodiment, if the predefined number of attempts has been exceeded, the process 400, at step 430, sends an alert for manual intervention. For example, an email or other type of message may be sent to alert an onboarding consultant of the issue regarding an incomplete or inaccurate response to a question. If the predefined number of attempts has not been exceeded, the process 400, at step 432, informs the new trading partner that answer is incorrect. In an embodiment, the process 400, at step 434, provides options with varying confidence scores to the new trading partner for answering the question.

Back at step 408, if the process 400 determines that the answer is complete and correct, the process 400, at step 410, determines whether there are more questions. If there are more questions, the process 400, at step 404, provides the new trading partner the next question to be answered. If there are no more questions, the process 400, at step 412, initiates a blockchain transaction to send the data to nodes in the BBN for endorsement. A transaction is declared valid only if it has been endorsed according to an endorsement policy. Transactions have to be endorsed by the BBN and only endorsed transactions may be committed and have an effect on the state of the blockchain. In an embodiment, the endorsing peers (e.g., the set of EPs 212 in FIG. 2) simulate a transaction and produce an endorsement signature. At step 416, the process 400 determines whether the blockchain has validated the transaction and written the transaction to the blockchain ledger. For example, when enough endorsement signatures are obtained to conclude that the transaction proposal is endorsed, the ordering node validates the transaction and delivers the transaction to the committing peers (e.g., the set of Committing Peers 216 in FIG. 2) to commit the transaction to the blockchain ledger. If the transaction is not validated, the process 400, at step 418, generates an alert for manual intervention (e.g., by the onboarding consultant 240 in FIG. 2), who then helps the new business trading partner to complete the survey form, which then has to be re-validated by the BBN.

Once the transaction is validated and written to the blockchain ledger, the process 400, at step 420, can retrieve the filled out survey forms from a database (e.g., the partner onboarding database 230 in FIG. 2), and use the answers to the questions on the survey form to train itself using the new information. At step 422, the process 400 determines whether there are additional business trading partners that require onboarding. If there are additional business trading partners that require onboarding, the process 400 submits the trading partner onboarding survey to the new business trading partner as shown in FIG. 3, step 306, and the process 300 and 400 repeat for each additional business trading partner that require onboarding. Otherwise, the process 400 for onboarding a new business trading partner ends.

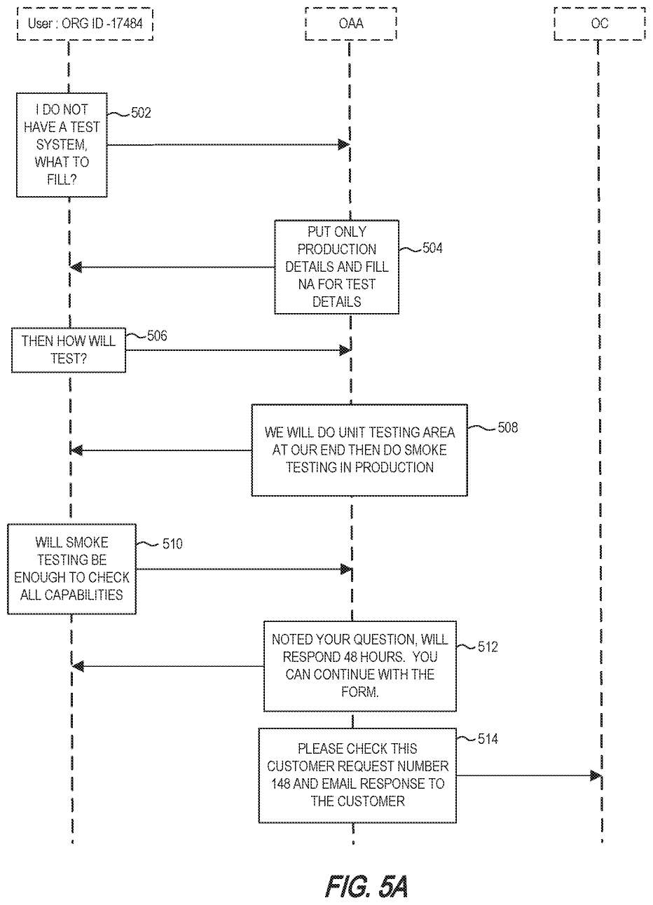

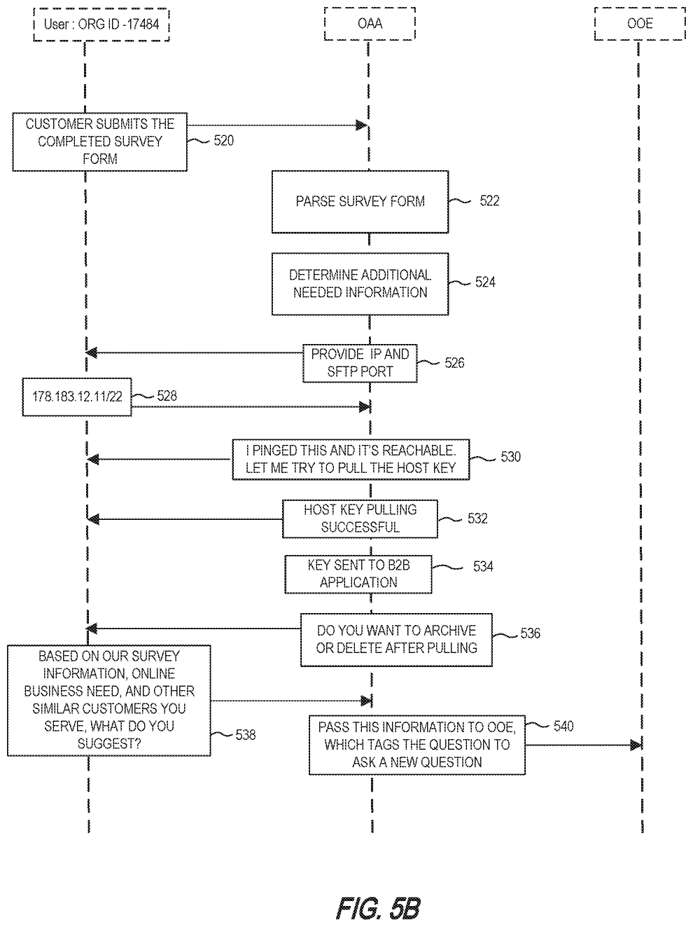

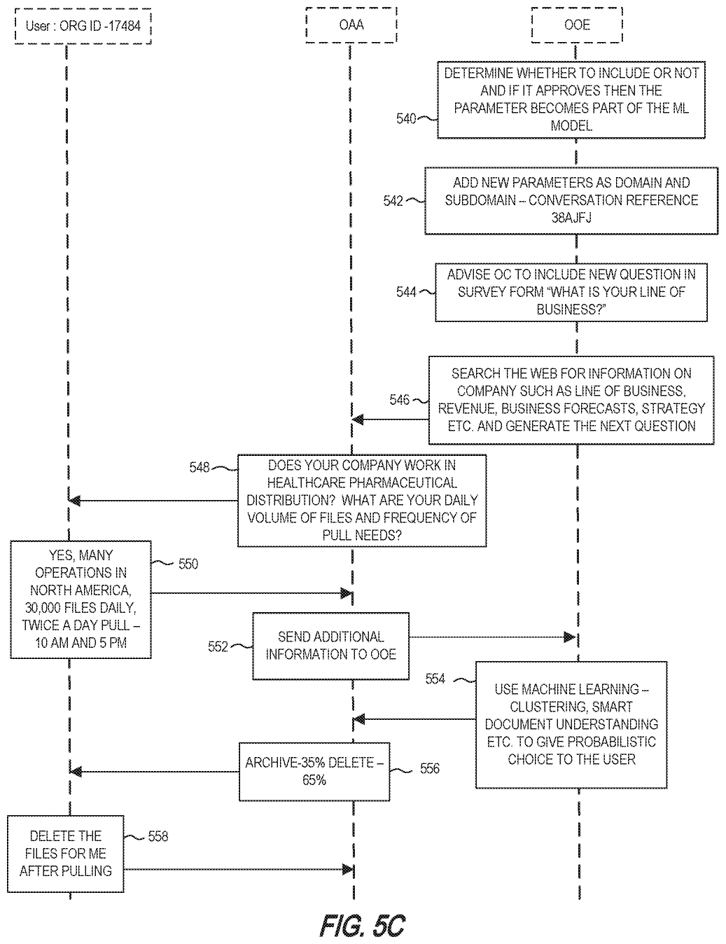

FIGS. 5A-5C illustrates an example dialogue for trading partner onboarding in accordance with an embodiment of the present disclosure. The dialogue starts after the user or new trading partner, having an organization ID (ORG ID) of 17484, has received a trading partner onboarding survey. The user submits a query (502) “I Do not have a test system, what to fill?” to the OAA of the AI onboarding system (e.g., Onboarding Automation Agent 202 in FIG. 2). Using its AI training, the OAA responds (504) with “Put only production details and fill NA for test details.” The user submits another query (506) “Then how will test?” The OAA responds (508) with “We will do unit testing area at our end then do smoke testing in production.” The user submits another query (510) “Will smoke testing be enough to check all capabilities?” In response to this query, the OAA is unable to determine an adequate response based on its prior training. The OAA responds (512) to the user by stating “Noted your question, will respond 48 hours. You can continue with the form.” The OAA can then forward the query to an onboarding consultant. For example, the OAA can send a message (514) to the onboarding consultant that says “Please check this customer request number 148 and email response to the customer.”

On FIG. 5B, the user submits the completed survey form to the OAA (520). The OAA parses the completed survey form to obtain the user-provided information on the survey form (522). For example, if the OAA determines that the user selected the Secure File Transfer Protocol (SFTP) option for trading partner onboarding, the OAA can pull the customer file to determine if additional information is needed (524). For instance, the customer file may not include the Internet Protocol (IP) and SFTP port of the trading partner. The OAA can then request (526) that the user “Provide IP and SFTP port.” The user responds (528) with “178.183.12.11/22.” Using this information, the OAA can attempt to ping the trading partner system of the user. If it is successful, the OAA can inform (530) the user that “I pinged this and it's reachable. Let me try to pull the host key.” The host key is used for providing secure communication. The OAA can notify (532) the user that it was successful in pulling the host key, which can be passed (534) to a business to business (B2B) application. B2B applications are applications used to exchange goods and services with each other.

In the depicted embodiment, the OAA can ask (536) the user “Do you want to archive or delete after pulling?” The user responds (538) with “Based on our survey information, online business need, and other similar customers you serve, what do you suggest?” If the OAA cannot respond to the user's question, it can pass the question on to an onboarding consultant (OC). The OAA can also pass (540) this information/question on to the OOE (e.g., the Onboarding Optimization Engine 204 in FIG. 2), which can tag the question as a new question.

In FIG. 5C, the OOE can decide (540) whether to include in the training data. For example, if the OOE approves the new question, then the parameter becomes part of the ML model. For example, the OOA can add (542) new parameters as domain and subdomain, with a reference to conversation 38ajfj. The OAA can also advise (544) the OC to include a new question such as “What is your line of business?” in the trading partner survey form. This process of dynamically determining and providing new parameters to the domain-specific ML clustering model enables dynamic refinement/improvement of the model. Using the information obtain from the parsed trading partner survey form, the OOE can attempt to obtain additional information about the trading partner to ask follow up questions. For example, the OOE can search (546) the web for information on the company such as line of business, revenue, business forecasts, strategy, etc., and generate the next question, which gets passed to the OAA. As an example, the OAA can ask (548) “Does your company work in healthcare pharmaceutical distribution?” and “What are your daily volume of files and frequency of pull needs?” The user can respond (550) with “Yes, many operations in North America, 30,000 files daily, twice a day pull—10 am and 5 pm.” This additional information can then be sent (552) to the OOE for additional optimization. For instance, the OAA can use (554) machine learning—clustering, smart document understanding etc., to provide probabilistic choices to the user. Based on its training, the OOE can inform (556) the OAA that 35% of customers have their files archived after pulling, and 65% have their files deleted. This information can be passed on to the user. The user can then request (558) to “delete the files for me after pulling.”

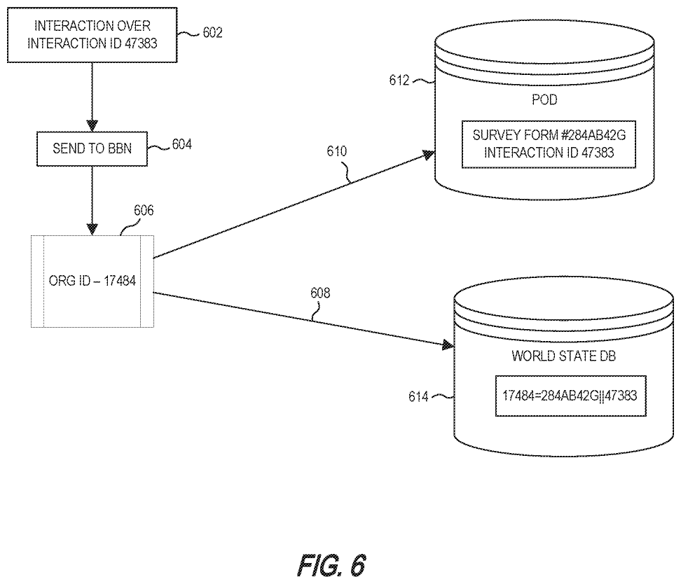

FIG. 6 is a schematic diagram illustrating a trading partner onboarding updating process in accordance with an embodiment of the present disclosure. This process can be performed once the interaction between the AI onboarding system and the user is complete as described in FIG. 3 and FIG. 4. In the depicted embodiment, the survey form and interaction data (602) is sent to the BBN (604). An Interaction identifier (INTERACTION ID) of 47383 is assigned to the interaction with the new trading partner. The BBN retrieves (606) an ID associated with the trading partner (ORG ID). In the depicted embodiment, the ORG ID is 17484. The BBN updates (608) the World State DB 614 (e.g., World State 218 in FIG. 2) to store the following name value pair: <ORG ID>=<SURVEY FORM NO>∥<INTERACTION ID> (i.e., 17484=284AB42G∥47383). Physical copies of the survey form (Survey Form #284AB42G) and interaction document (Interaction ID 47383) are stored (610) in a partner onboarding database 612 (e.g., POD 230 in FIG. 2) as off-chain data (i.e., not part of the blockchain in the BBN).

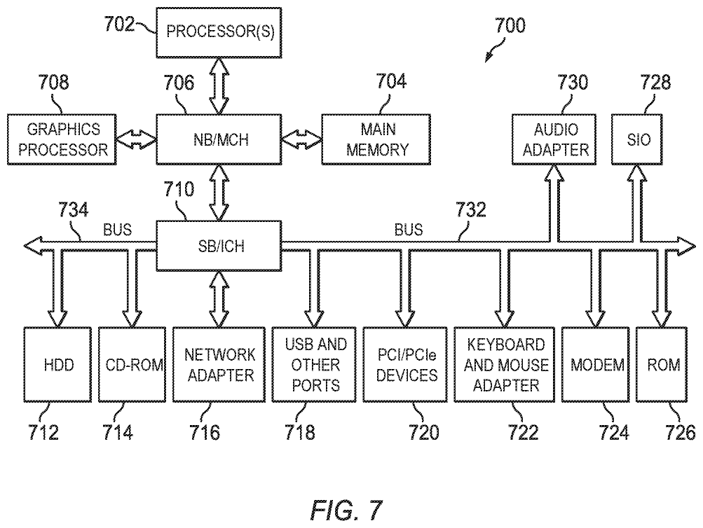

FIG. 7 is a block diagram illustrating a hardware architecture of a system 700 according to an embodiment of the present disclosure in which aspects of the illustrative embodiments may be implemented. For example, in one embodiment, AI onboarding system 102 of FIG. 1 may be implemented using the data processing system 700. Additionally, the data processing system 700 may be configured to store and execute instructions for performing the process described in FIGS. 3-6. In the depicted example, the data processing system 700 employs a hub architecture including north bridge and memory controller hub (NB/MCH) 706 and south bridge and input/output (I/O) controller hub (SB/ICH) 710. Processor(s) 702, main memory 704, and graphics processor 708 are connected to NB/MCH 706. Graphics processor 708 may be connected to NB/MCH 706 through an accelerated graphics port (AGP). A computer bus, such as bus 732 or bus 734, may be implemented using any type of communication fabric or architecture that provides for a transfer of data between different components or devices attached to the fabric or architecture.

In the depicted example, network adapter 716 connects to SB/ICH 710. Audio adapter 730, keyboard and mouse adapter 722, modem 724, read-only memory (ROM) 726, hard disk drive (HDD) 712, compact disk read-only memory (CD-ROM) drive 714, universal serial bus (USB) ports and other communication ports 718, and peripheral component interconnect/peripheral component interconnect express (PCI/PCIe) devices 720 connect to SB/ICH 710 through bus 732 and bus 734. PCI/PCIe devices may include, for example, Ethernet adapters, add-in cards, and personal computing (PC) cards for notebook computers. PCI uses a card bus controller, while PCIe does not. ROM 726 may be, for example, a flash basic input/output system (BIOS). Modem 724 or network adapter 716 may be used to transmit and receive data over a network.

HDD 712 and CD-ROM drive 714 connect to SB/ICH 710 through bus 734. HDD 712 and CD-ROM drive 714 may use, for example, an integrated drive electronics (IDE) or serial advanced technology attachment (SATA) interface. In some embodiments, HDD 712 may be replaced by other forms of data storage devices including, but not limited to, solid-state drives (SSDs). A super I/O (SIO) device 728 may be connected to SB/ICH 710. SIO device 728 may be a chip on the motherboard that is configured to assist in performing less demanding controller functions for the SB/ICH 710 such as controlling a printer port, controlling a fan, and/or controlling the small light emitting diodes (LEDS) of the data processing system 700.

The data processing system 700 may include a single processor 702 or may include a plurality of processors 702. Additionally, processor(s) 702 may have multiple cores. For example, in one embodiment, data processing system 700 may employ a large number of processors 702 that include hundreds or thousands of processor cores. In some embodiments, the processors 702 may be configured to perform a set of coordinated computations in parallel.

An operating system is executed on the data processing system 700 using the processor(s) 702. The operating system coordinates and provides control of various components within the data processing system 700 in FIG. 7. Various applications and services may run in conjunction with the operating system. Instructions for the operating system, applications, and other data are located on storage devices, such as one or more HDD 712, and may be loaded into main memory 704 for execution by processor(s) 702. In some embodiments, additional instructions or data may be stored on one or more external devices. The processes described herein for the illustrative embodiments may be performed by processor(s) 702 using computer usable program code, which may be located in a memory such as, for example, main memory 704, ROM 726, or in one or more peripheral devices.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random-access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented method, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. Further, the steps of the methods described herein may be carried out in any suitable order, or simultaneously where appropriate. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method implemented by an AI onboarding system for performing trading partner onboarding, the computer-implemented method comprising:
performing artificial intelligence (AI) training using machine learning (ML) to learn onboarding information requirements based on prior business trading partner survey information for business to business (B2B) trading partners;
submitting a transaction proposal to a blockchain business network (BBN) for obtaining a new business trading partner that requires trading partner onboarding;
transmitting a business trading partner survey to the new business trading partner to obtain business trading partner survey information;
monitoring for queries regarding the business trading partner survey from the new business trading partner;
providing responses to the queries based on the AI training; and
verifying using the AI training that the business trading partner survey is completed correctly by the new business trading partner.

2. The computer-implemented method of claim 1, further comprising identifying additional questions based on the information provided by the new business trading partner on the business trading partner survey.

3. The computer-implemented method of claim 2, further comprising sending responses to all questions collected from the new business trading partner to the BBN for endorsement and validation.

4. The computer-implemented method of claim 3, further comprising storing the responses to all questions collected from the new business trading partner in a Partner Onboarding Database (POD) after being validated by the BBN.

5. The computer-implemented method of claim 3, further comprising raising an alert for manual intervention by an onboarding consultant if a response to a question if not validated by the BBN.

6. The computer-implemented method of claim 1, further comprising notifying an onboarding consultant for any query that the AI onboarding system is unable to provide a response to the new business trading partner.

7. The computer-implemented method of claim 1, further comprising providing a ranking of the responses to a query based on the prior business trading partner survey information of the B2B trading partners.

8. The computer-implemented method of claim 1, further comprising processing the queries regarding the business trading partner survey from the new business trading partner using natural language processing (NLP).

9. The computer-implemented method of claim 1, further comprising storing document identifiers along with the corresponding organization identifier (ID) and interaction ID in the BBN.

10. The computer-implemented method of claim 1, further comprising storing the business trading partner survey completed by the new business trading partner in a Partner Onboarding Database (POD).

11. The computer-implemented method of claim 10, further comprising periodically performing additional AI training using updated business trading partner survey information in the POD.

12. The computer-implemented method of claim 1, further comprising receiving organization ID of the new business trading partner from the BBN after proper endorsement and validation.

13. The computer-implemented method of claim 1, further comprising determining new parameters to a domain-specific ML clustering model to dynamically refine the domain-specific ML clustering model to improve the AI training.

14. A system configured to provide trading partner onboarding, the system comprising memory for storing instructions, and a processor configured to execute the instructions to:
perform artificial intelligence (AI) training using machine learning (ML) to learn onboarding information requirements based on prior business trading partner survey information for business to business (B2B) trading partners;
submit a transaction proposal to a blockchain business network (BBN) for obtaining a new business trading partner that requires trading partner onboarding;
transmit a business trading partner survey to the new business trading partner to obtain business trading partner survey information;
monitor for queries regarding the business trading partner survey from the new business trading partner;
provide responses to the queries based on the AI training; and
verify using the AI training that the business trading partner survey is completed correctly by the new business trading partner.

15. The system of claim 14, wherein the processor further executes instructions to identify additional questions based on the information provided by the new business trading partner on the business trading partner survey.

16. The system of claim 15, wherein the processor further executes instructions to send responses to all questions collected from the new business trading partner to the BBN for endorsement and validation.

17. The system of claim 16, wherein the processor further executes instructions to raise an alert for manual intervention by an onboarding consultant if a response to a question if not validated by the BBN.

18. The system of claim 14, wherein the processor further executes instructions to notify an onboarding consultant for any query that the AI onboarding system is unable to provide a response to the new business trading partner.

19. The system of claim 14, wherein the processor further executes instructions to store document identifiers along with the corresponding organization ID and interaction ID in the BBN.

20. A computer program product for providing trading partner onboarding, the computer program product comprising a computer readable storage medium having program instructions embodied therewith, the program instructions executable by a processor of an onboarding system to cause the onboarding system to:
perform artificial intelligence (AI) training using machine learning (ML) to learn onboarding information requirements based on prior business trading partner survey information for business to business (B2B) trading partners;
submit a transaction proposal to a blockchain business network (BBN) for obtaining a new business trading partner that requires trading partner onboarding;
transmit a business trading partner survey to the new business trading partner to obtain business trading partner survey information;
monitor for queries regarding the business trading partner survey from the new business trading partner;
provide responses to the queries based on the AI training; and
verify using the AI training that the business trading partner survey is completed correctly by the new business trading partner.
